(19) United States
(12) Patent Application Publication
(10) Pub. No.: US 2023/0177879 A1
(43) Pub. Date: Jun. 8, 2023

(54) VIDEOCONFERENCE IRIS POSITION ADJUSTMENTS

(71) Applicant: HEWLETT-PACKARD DEVELOPMENT COMPANY, L.P., Spring, TX (US)

(72) Inventor: Lee Atkinson, Taipei City (TW)

(73) Assignee: HEWLETT-PACKARD DEVELOPMENT COMPANY, L.P., Spring, TX (US)

(21) Appl. No.: 17/542,709

(22) Filed: Dec. 6, 2021

(51) Int. Cl. G06K 9/00; G06K 9/32; G06K 9/62; H04N 7/15

(52) U.S. Cl. CPC G06K 9/00617; G06K 9/32; G06K 9/6202; H04N 7/15

(57) ABSTRACT

An example non-transitory machine-readable storage medium includes instructions to, when executed by the processor, cause the processor to detect that a local participant in a videoconference is looking at a first remote participant window of a plurality of participant windows, wherein the plurality of participant windows is displayed via the computing device and the local participant is a user of the computing device. The example instructions are also executable to capture an image of a face of the local participant based on the detection and adjust a position of an iris of the local participant from a side position to a center position. The instructions are also executable to transmit the iris position adjustment to a plurality of remote participant computing devices to change an appearance of the local participant in a participant window displayed in a first remote participant computing device of the plurality of remote participant computing devices.

### BACKGROUND

Through videoconferencing, users can communicate with one another remotely. A capture device on each participant’s computing device captures images of the participant on his/her own computing device and transmits these images to other participant computing devices. Accordingly, users can communicate via audio and video to emulate a real-world interaction.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a flowchart of a method for adjusting and transmitting iris positions at a local participant computing device, according to an example.

FIG. 2 depicts a local participant computing device for adjusting and transmitting iris positions at a local participant computing device, according to an example.

FIG. 3 is a flowchart of a method for receiving raw data for iris position adjustments from a remote participant computing device, according to an example.

FIG. 4 depicts a local participant computing device for receiving raw data for iris position adjustments from a remote participant computing device, according to an example.

FIG. 5 depicts a local participant computing device for adjusting iris positions in a videoconference, according to an example.

FIG. 6 depicts a non-transitory machine-readable storage medium for adjusting iris positions at a computing device, according to an example.

FIG. 7 depicts a non-transitory machine-readable storage medium for adjusting and transmitting iris positions at a local participant computing device, according to an example.

FIG. 8 depicts a non-transitory machine-readable storage medium for receiving raw data for iris position adjustments from a remote participant computing device, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Videoconferencing refers to an environment where different users can communicate with one another via video and audio streams. Specifically, a capture device on a computing device captures video images of a user looking at the computing device and a microphone captures audio of the user. This information is transmitted and displayed on the computing devices of other participants such that the participants may communicate with one another, even when not in the same room. Videoconferencing has provided flexibility and new avenues of interaction. However, some developments may enhance the efficacy of videoconferencing and the communication that takes place therein.

For example, eye contact in human interactions demonstrates attentiveness during communications and may impact the quality and efficacy of interpersonal communications. However, the hardware arrangement of a computing device may create a break in eye contact between two users. For example, a capture device may be placed in a bezel on top of the display device. Rather than looking at the capture device, which would give the appearance at a remote device as if the local participant is maintaining eye contact, the local participant may look at the window which displays the video stream of the remote participant. This may give the appearance at the remote participant computing device that the local participant is not looking at, or paying attention to, the remote participant. That is, the discrepancy between capture device position and where the local participant is looking on his/her screen, i.e., the window that depicts the participant that they are communicating with, reduces the efficacy of videoconferencing communication as the local participant may appear to be looking elsewhere while communicating with a particular recipient.

Accordingly, the present specification tracks a local participant’s gaze. In response to determining that the local participant’s gaze is on a particular participant of the videoconference, the image of the iris of the local participant is adjusted such that on the particular participant’s computing device, a graphical user interface is generated that shows the local participant as if they are looking at the remote participant, rather than some other location. That is, the present specification provides for eye correction to alter an image of the local participant so it appears as if they are in one-to-one engagement with the particular participant they are communicating with. As described below, such adjustment may be made either prior to transmission or following transmission.

However, in a videoconference there may be multiple participants and correcting the iris position of each participant may be unnatural and may cause confusion by giving the appearance that each participant is engaged with each and every other participant throughout the duration of the videoconference.

Accordingly, the present specification detects the gaze of the local participant and captures a layout of the participant windows on the local participant computing device. This information is used to determine when the local participant is looking at a first remote participant window. This information is used to adjust the iris position of the local participant, either at the local participant computing device or the remote participant computing device, to give the appearance to both 1) the first remote participant that the local participant is engaging with and 2) other remote participants, that the local participant is maintaining eye contact with the first remote participant.

Specifically, the present specification describes a non-transitory machine-readable storage medium encoded with instructions executable by a processor of a computing device. As used in the present specification, the term “non-transitory” does not encompass transitory propagating signals. When executed by the processor, the instructions cause the processor to detect that a local participant in a videoconference is looking at a first remote participant window of a plurality of participant windows. The plurality of participant windows is displayed via the computing device and the local participant is a user of the computing device. The instructions also cause the processor to capture an image of a face of the local participant based on the detection and adjust a position of an iris of the local participant from a side position to a center position. The instructions are also executable to transmit the iris position adjustment to a plurality of remote participant computing devices to change an appearance of the local participant in a participant window displayed in the first remote participant computing device of the plurality of remote participant computing devices.

In another example, the non-transitory machine-readable storage medium includes instructions executable by a processor of the computing device to, when executed by the processor, cause the processor to receive an indication that a first remote participant in a videoconference is looking at a local participant window of a plurality of participant windows, wherein the plurality of participant windows is displayed via a first remote participant computing device and the local participant is a user of the computing device. The instructions cause the processor to adjust a position of an iris of the first remote participant from a side position to a center position and display a first remote participant window based on the iris position adjustment for the first remote participant.

In another example, the non-transitory machine-readable storage medium includes instructions to, when executed by the processor, cause the processor to detect that a local participant in a videoconference is looking at a first remote participant window of a plurality of participant windows, wherein the plurality of participant windows is displayed via a local participant computing device. The instructions also cause the processor to 1) based on a window layout of a first remote participant computing device adjust a position of an iris of the local participant from a side position to a position focused on the first remote participant and 2) based on a window layout of a second remote participant computing device adjust a position of the iris of the local participant from the side position to the position focused on the first remote participant.

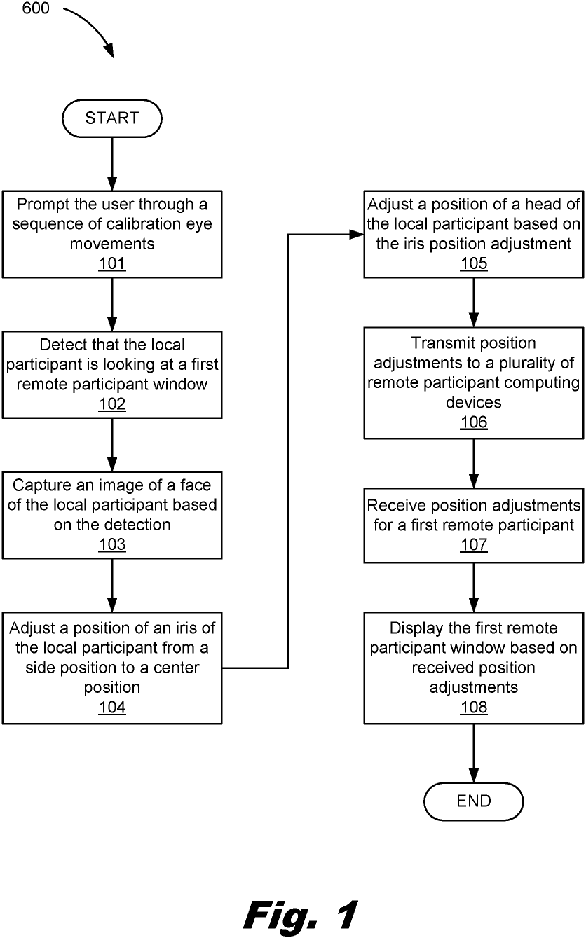

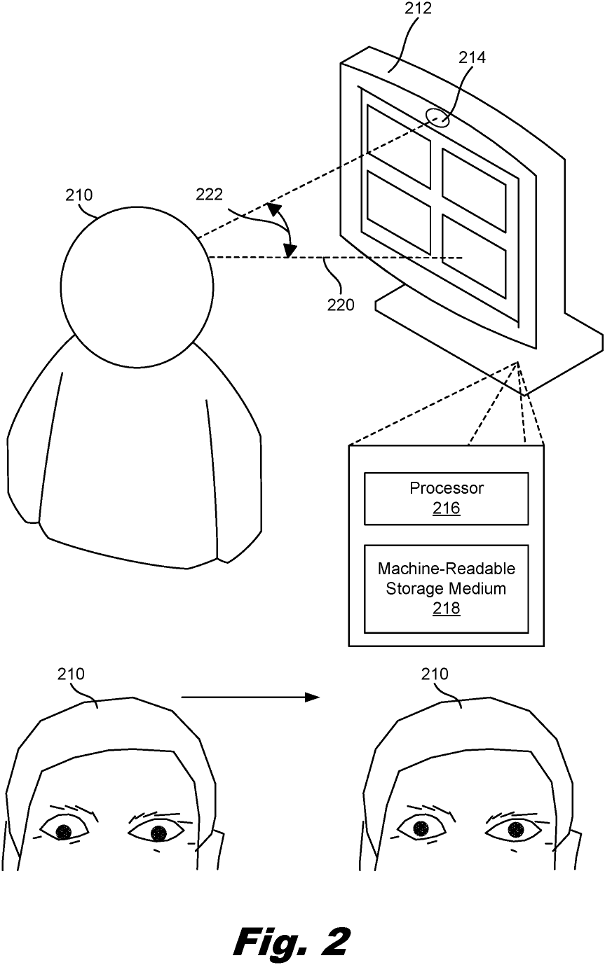

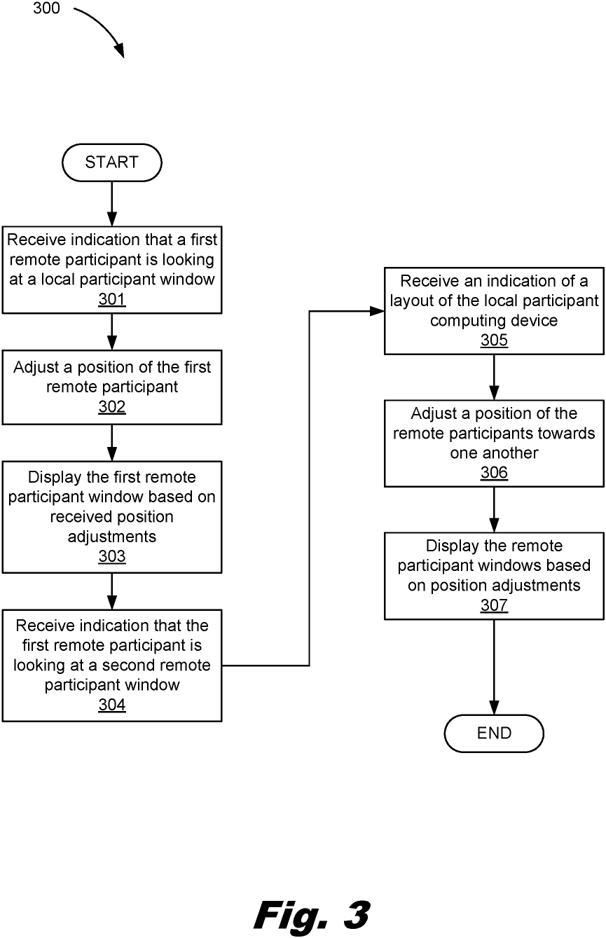

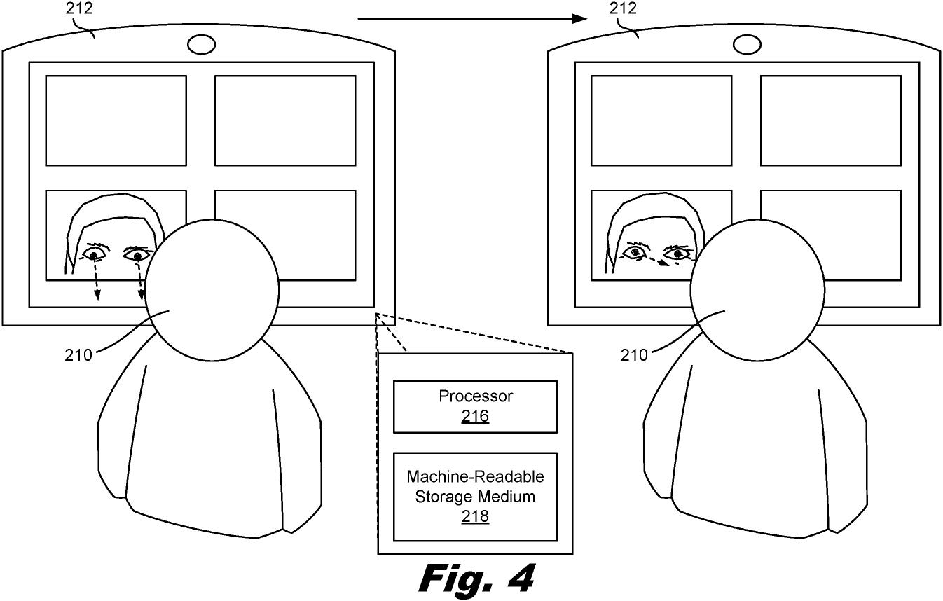

Turning now to the figures, FIG. 1 is a flowchart of a method 100 for adjusting and transmitting iris positions at a local participant computing device, according to an example. Specifically, FIG. 1 depicts a flowchart of a method 100 wherein iris adjustments are made to images of the local participant prior to transmission. FIG. 2 depicts a diagram of a local participant computing device that performs the adjustments prior to transmission. By comparison, FIGS. 3 and 4 depict a method and computing device that receive raw data from a remote participant computing device. That is, FIGS. 1 and 2 depict iris position adjustments made before transmission while FIGS. 3 and 4 depict iris position adjustments made after transmission.

At step 101, the method 100 includes prompting the local participant through a sequence of eye calibration movements. That is, a processor of the local participant computing device may prompt the local participant through the sequence of calibration eye movements. Doing so may calibrate the computing device to recognize and track the user gaze across the computing device. In such an example, the computing device may prompt the local participant to make a sequence of eye movements such as a left-to-right movement and a top-to-bottom movement.

At step 102, the method 100 includes detecting that the local participant is looking at a first remote participant window of a plurality of participant windows. The plurality of participant windows is displayed on the computing device and in this example, the local participant is a user of the computing device where the plurality of participant windows is displayed.

To determine that the local participant is looking at a first remote participant window, the processor may determine a local participant gaze region on the computing device. The gaze region indicates where on the computing device the local participant is looking. In one example, the computing device includes or is coupled to a sensing device that includes a light source and a camera or video camera. The angle of the pupil of the local participant and a speck of light reflected from the cornea of the local participant may be tracked. This information may be used to extrapolate the rotation of the eye and the associated gaze region. The rotation of the eye and the gaze direction may be further analyzed and translated into a set of pixel coordinates, which show the presence of eye data points in different parts of the display device. From this sensing device data, the processor determines a gaze point for the local participant.

In another example, a camera may project a pattern of near-infrared light on the pupils. In this example, the camera may take high-resolution images of the local participant eyes and the patterns. The processor may then determine the eye position and gaze point based on the reflected patterns. In summary, the processor may identify, from a captured image, a gaze region for the local participant, which gaze region indicates a location on the computing device where the local participant is looking.

This gaze region information is compared to information regarding the position and size of participant windows on the computing device to determine that the local participant is looking at the first remote participant window. That is, during a videoconference, various participant windows may be displayed, each of which displays a video stream of a different participant in the videoconference. In displaying the participant windows, the computing device may generate or access metadata which is indicative of a location and a position of the participant windows. Such data may indicate coordinates of the boundary of the participant windows. Accordingly, the processor may extract a layout of windows on the computing device. Based on the gaze point and the layout of windows, the processor may detect that the local participant is looking at the first remote participant window. That is, the processor may compare the gaze region of the local participant to determine which of the participant windows the gaze region aligns with. For example, the gaze region of the local participant may be converted into x-y coordinates. When the processor determines that the x-y coordinates associated with the gaze region fall within the boundary of the first remote participant window, the processor indicates that the local participant is looking at the first remote participant window.

At step 103, the method 100 includes capturing an image of a face of the local participant. That is, a computing device may include or be coupled to a capture device such as a camera or a video camera. The camera may be positioned so as to capture an image of the user’s face as they are looking at the display device. This captured image or stream of captured images is passed to the computing devices of the other participants to be displayed thereon. However, as described above, prior to such transmission from the local participant’s computing device, the images may be adjusted.

At step 104, the method 100 includes adjusting a position of an iris of the local participant from a side position to a center position. As used in the present specification and in the appended claims, the term “center position” refers to a position wherein the pupils are centered in the sclera. This position may indicate to a remote participant that the local participant is looking directly at him/her.

The adjustment may take a variety of forms. For example, pixels associated with the eye may be re-drawn. That is, the processor may adjust pixels associated with the iris. Specifically, the processor may segment different components of the eye, i.e., the pupil, sclera, iris, etc. and re-locate or re-draw these components to generate a video stream of the local participant with the pupils centrally disposed within the sclera. Further, the eye sockets of the local participant may be enlarged and the eyelid may be retracted.

In so doing, the eyes of the local participant are adjusted away from a position depicting the user looking away from the capture device to a position depicting the user looking at the capture device. That is, the processor renders direct eye contact between the local participant and a remote participant even when actual direct eye contact may not exist on account of the local participant looking at the remote participant window instead of directly at his/her own capture device. Put another way, adjusting the iris position from a non-center position to a center position as described herein, gives the appearance of the local participant looking directly at the user on whose device the local participant is displayed.

In some examples, additional adjustments may be made. For example, at step 105, the method 100 includes adjusting a position of a head of the local participant based on the iris position adjustment. That is, in addition to adjusting the iris of the local participant to be directed to the first remote participant that they are engaging with, the head of the local participant may also be adjusted in a similar fashion, by for example, adjusting pixels associated with the head of the local participant. Specifically, the head of the local participant may be rotated up or down or to the left or right based on the determined difference between the gaze location for the local participant and the capture device.

In another example, the computing device may use the discrepancy already calculated for the iris position adjustment and determine how to adjust the head, i.e., adjust pixels associated with the head of the local participant, to effectuate a similar adjustment of the head of the local participant. Accordingly, the processor may adjust a position of a head of the local participant based on the iris position adjustment.

At step 106, the method 100 includes transmitting the position adjustments, i.e., the iris position adjustments and the head position adjustments, to a plurality of remote participant computing devices. That is, when the local participant is focusing and interacting with a first remote participant, the eye corrections to align the iris of the local participant from a side, or non-central position, to a center position, are transmitted to the other participants in the video conference. Doing so changes an appearance of the local participant in a participant window of the first remote participant computing device of the plurality of remote participant computing devices.

In addition to transmitting adjustments, the local participant computing device may receive a transmission of an adjustment from the first remote participant computing device. Accordingly, at step 107, the method 100 includes receiving position adjustments for a first remote participant. Such position adjustments may include an iris position adjustment for the first remote participant and a head position adjustment for the first remote participant. That is, the processor may receive from the first remote computing device, 1) an iris position for the first remote participant, which iris position is to adjust a position of an iris of the first remote participant from a side position to a second position and in some examples 2) a head position adjustment for the first remote participant based on the iris position adjustment.

At step 108, the method 100 includes displaying the first remote participant window based on the iris position adjustment, and in some cases the head position adjustment, for the first remote participant. That is, the processor may display the first remote participant window based on the iris position adjustment, and in some examples a head position adjustment, for the first remote participant.

FIG. 2 depicts a local participant computing device 212 for adjusting and transmitting iris positions at a local participant computing device 212, according to an example. That is, FIG. 2 depicts the computing device that executes the method 100.

The local participant computing device 212 may be of a variety of types including a desktop computer, a laptop computer, a tablet, or any of a variety of other computing devices. To execute its intended functionality, the local participant computing device 212 includes various hardware components, which may include a processor 216 and non-transitory machine-readable storage medium 218. The processor 216 may include the hardware architecture to retrieve executable code from the non-transitory machine-readable storage medium 218 and execute the executable code. As specific examples, the local participant computing device 212 as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The non-transitory machine-readable storage medium 218 stores computer usable program code for use by or in connection with an instruction execution system, apparatus, or device. The non-transitory machine-readable storage medium 218 may take many types of memory including volatile and non-volatile memory. For example, the memory may include Random Access Memory (RAM), Read Only Memory (ROM), optical memory disks, and magnetic disks, among others. The executable code may, when executed by the processor 216 cause the processor 216 to implement the functionality described herein.

As described above, a local participant 210 may be engaging in a videoconference where a capture device 214 captures images of the local participant 210. During such a videoconference, the local participant 210 may be looking at a first remote participant window as indicated by the dashed line 220. However, due to the discrepancy angle 222 between the capture device 214 line of sight and the actual gaze region of the local participant 210, it may appear at the first remote participant computing device as if the local participant 210 is looking down as depicted at the bottom left of FIG. 2. Accordingly, the processor 216 may detect the gaze point of the local participant 210 and make an adjustment to the image such that the user’s irises are moved from a side, or non-centered, position to a center position as depicted in the bottom right of FIG. 2. Moving the irises to a center position conveys direct eye contact to the first remote participant.

In another example, the processor 216 of the computing device 212 may compare a captured image against a training set of images of user eye positions. In this example, once the gaze direction of the local participant 210 is determined, this gaze direction information may be acted upon by the processor 216. Specifically, the processor 216 may adjust the position of the iris of the local participant based on the training set.

FIG. 3 is a flowchart of a method 300 for receiving raw data for iris position adjustments from a remote participant computing device, according to an example. That is, as compared to FIGS. 1 and 2, where adjustments were sent to a participant computing device, in the example depicted in FIGS. 3 and 4, raw data is sent to a participant computing device, and the receiving device makes the adjustments. As such, FIG. 3 depicts a flowchart of a method 300 wherein iris adjustments are made to images of the first remote participant following receipt of the images from the first remote participant computing device.

At step 301, the method 300 includes receiving an indication that a first remote participant in a video conference is looking at a local participant window of a plurality of participant windows. In this example the plurality of participant windows is displayed on a first remote computing device and the local participant is a user of the computing device where the adjustments are made. That is, in this example, rather than the local participant computing device performing the adjustment on the local participant image, the local participant computing device receives raw data from the first remote participant computing device and performs the adjustment on the received first remote participant image.

The raw data, or the received indication, may come in a variety of forms. For example, the local participant computing device 212 may receive raw data that indicates a gaze region for the first remote participant and a position of a capture device on the first remote participant computing device. From this information, the processor 216 may determine a discrepancy angle between the gaze region and the capture device. The discrepancy angle serves as the basis for any adjustment to the iris position in the stream of images of the first remote participant.

In yet another example, rather than determining the discrepancy angle, the processor 216 may receive a calculated discrepancy angle between the gaze region for the first remote participant and a position of a capture device on the first remote participant computing device.

The received indication may indicate a window layout on the first remote participant computing device. As described above, such information may include coordinates of the different windows on the first remote participant computing device. The information on the layout of windows on the remote participant computing device in conjunction with the gaze region information may allow the processor 216 to determine which window the first remote participant is looking at as described above in connection with FIG. 1.

At step 302, the method 300 includes adjusting a position of an iris of the first remote participant from a side position to a center position. In this example, the adjustment is performed following transmission of raw data as opposed to being performed before transmission. That is, FIG. 1 depicts a method 100 executed on a local participant computing device 212 that performs iris adjustment and transmits the adjustment values to remote participant computing devices and FIG. 3 depicts a method 300 executed on the local participant computing device 212 that receives raw data, i.e., captured images, of a first remote participant and performs the adjustment.

At step 303, the method 300 includes displaying the first remote participant window based on the iris position adjustment for the first remote participant. Again, rather than performing an adjustment for the user of the computing device and transmitting the adjustment to a different device, in this example, the processor 216 performs an adjustment for the user of another computing device and display the adjustments on the local participant computing device 212.

As described above, in some examples additional adjustments may be made. Accordingly, the processor 216 may adjust a head position of the first remote participant based on the iris position adjustment. This may be performed as described above in connection with FIG. 1, although in the example depicted in FIG. 3, such adjustments are performed for the first remote participant.

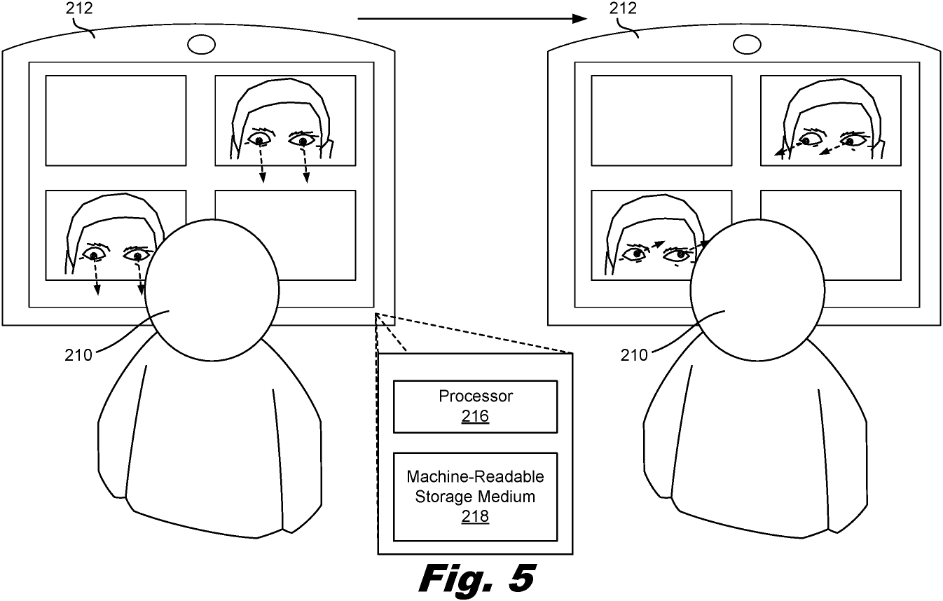

At step 304, the method 300 includes receiving an indication that the first remote participant is looking at a second remote participant window. As depicted in FIG. 5, it may be that the local participant 210 is watching two other participants communicate with one another. Accordingly, rather than adjusting the iris position of the other participants to be looking at the local participant 210, the iris positions of the other participants may be adjusted to look towards one another.

At step 305, the method 300 includes receiving an indication of a layout of windows on the computing device. As depicted in FIG. 5, the layout of windows on the local participant computing device 212 facilitates the adjustment of the iris position and in some examples the head position of the remote participants. Accordingly, at step 306, the method 300 includes adjusting a position of an iris of the first remote participant towards a second remote participant window. This may be performed by the processor 216 as described above. In some examples, the processor 216 adjusts a position of a head of the first remote participant based on the iris position adjustment of the first remote participant.

In addition to performing adjustments for the first remote participant, in the case where the first remote participant is looking towards a second remote participant, the processor 216 may adjust a position of an iris of the second remote participant towards the first remote participant window and to adjust a position of a head of the second remote participant based on the iris position adjustment of the second remote participant towards the first remote participant.

At step 307, the method 300 includes displaying the first remote participant window and the second remote participant window based on received position adjustments.

FIG. 4 depicts a local participant computing device 212 for receiving raw data for iris position adjustments from a remote participant computing device, according to an example. Specifically, FIG. 4 depicts adjustments made to the first remote participant image at the local participant computing device 212. That is, FIG. 4 depicts the computing device that executes the method 300.

FIG. 4 depicts two instances of the local participant computing device 212. Prior to, or without an adjustment, the first remote participant gaze direction may be downward which occurs as a result of the object of the first remote participants vision being the local participant window on the first remote participant computing device rather than towards the capture device of the first remote participant computing device. The direction of vision of the first remote participant in the first instance is depicted in dashed arrows.

By comparison, a second instance of the local participant computing device 212 is depicted on the left where the first remote participant’s iris position has been adjusted towards a center position so as to indicate or emulate direct eye-to-eye contact with the local participant 210. That is, the local participant 210 sees the first remote participant as having direct eye contact with them.

FIG. 5 depicts a local participant computing device 212 for adjusting iris positions in a videoconference, according to an example. Specifically, FIG. 5 depicts how images of a first and second remote participant change at the local participant computing device 212 when remote participants are communicating with one another rather than with the local participant 210. That is, in the example depicted in FIGS. 2 and 4, the iris position of the first remote participant was adjusted to a center location to indicate eye-to-eye contact and engagement with the local participant 210 to reflect the interaction between the first remote participant and the local participant 210. However, at different points in time, the first remote participant may be conversing or engaging with a second remote participant, rather than the local participant 210. In this example, the processor 320 may adjust the iris position of the first remote participant and the second remote participant to be looking at one another as depicted in the second instance of the local participant computing device 212.

In this example, the processor 216 may receive an indication of the layout of windows on the local participant computing device 212. That is, the adjustment to the iris position of both the first and the second remote participant may be based on the layout of windows on the local participant computing device 212. For example, as depicted in FIG. 5, if the first remote participant window is a lower left window and the second remote participant window is an upper right window, the adjustment to the first remote participant image may be to move the iris position from a side position to an upper right position. However, if the first remote participant window is in a lower left window and the second remote participant window is in the lower right window, then the adjustment to the first remote participant image may be to move the iris position from a down position to a right position.

As described above, the computing device may generate or access metadata which is indicative of a location and a position of the participant windows. Such data may indicate coordinates of the boundary of the participant windows. Accordingly, the processor 216 may receive as inputs the remote participant window that the local participant is looking at, metadata or data indicating the layout of windows on the local participant computing device 212, and an association of each participant window with a particular remote participant. Based on this information, the processor 216 may adjust the iris position of the first remote participant and the second remote participant such that both participants eyes are directed towards the participant window associated with the other as depicted in FIG. 5. As depicted in FIG. 5, in this example, the local participant 210 would not see the first participant maintaining eye contact with the him/her, but would see the first remote participant maintaining eye contact with the second remote participant.

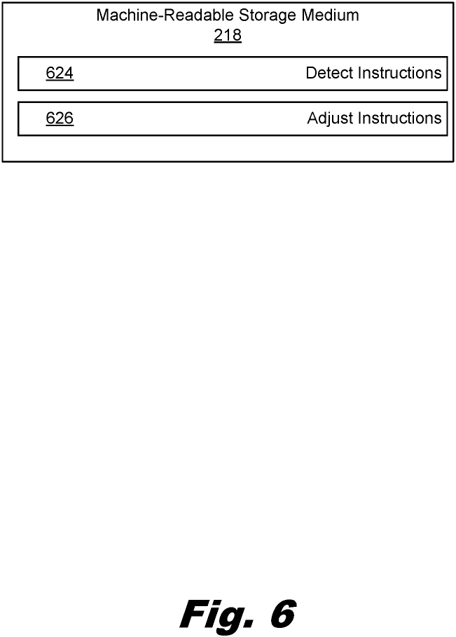

FIG. 6 depicts a non-transitory machine-readable storage medium 218 for adjusting iris positions at a computing device, according to an example. In an example, the computing device may be the local participant computing device, the remote participant computing device, or a separate computing device such as a server.

As used in the present specification, the term “non-transitory” does not encompass transitory propagating signals. To achieve its desired functionality, a computing device includes various hardware components. Specifically, a computing device includes a processor and a machine-readable storage medium 218. The machine-readable storage medium 218 is communicatively coupled to the processor. The machine-readable storage medium 218 includes a number of instructions 624 and 626 for performing a designated function. The machine-readable storage medium 218 causes the processor to execute the designated function of the instructions 624 and 626. The machine-readable storage medium 218 can store data, programs, instructions, or any other machine-readable data that can be utilized to operate the computing device. Machine-readable storage medium 218 can store computer readable instructions that the processor of the computing device can process, or execute. The machine-readable storage medium 218 can be an electronic, magnetic, optical, or other physical storage device that contains or stores executable instructions. Machine-readable storage medium 218 may be, for example, Random Access Memory (RAM), an Electrically Erasable Programmable Read-Only Memory (EEPROM), a storage device, an optical disc, etc. The machine-readable storage medium 218 may be a non-transitory machine-readable storage medium 218.

Referring to FIG. 6, detect instructions 624, when executed by the processor 216, cause the processor 216 to, detect that a local participant 210 in a videoconference is looking at a first remote participant window of a plurality of participant windows, wherein the plurality of participant windows is displayed via a local participant computing device 212. Adjust instructions 626, when executed by the processor 216, may cause the processor 216 to, based on a window layout of a first remote participant computing device, adjust a position of an iris of the local participant 210 from a side position to a position focused on the first remote participant. Based on a window layout of a second remote participant computing device, the adjust instructions 626, when executed by the processor 216, may cause the processor 216 to adjust a position of an iris of the local participant 210 from a side position to a position focused on the first remote participant.

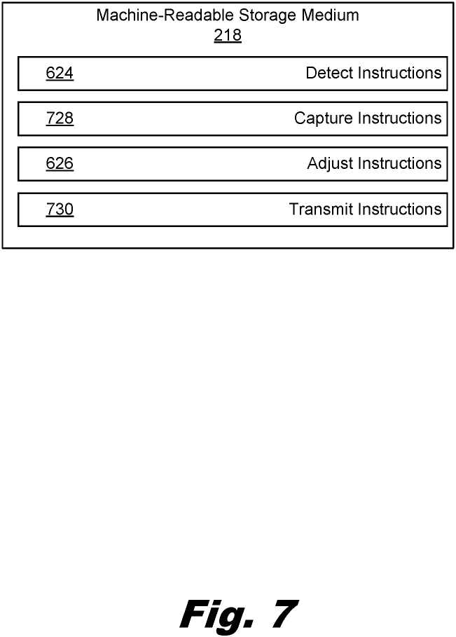

FIG. 7 depicts a non-transitory machine-readable storage medium 218 for adjusting and transmitting iris positions at a local participant computing device 212, according to an example. That is, FIG. 7 depicts machine-readable storage medium 218 instructions for executing the method 100.

Detect instructions 624, when executed by the processor 216, cause the processor 216 to, detect that a local participant 210 in a videoconference is looking at a first remote participant window of a plurality of participant windows as described above in connection with FIG. 1. The plurality of participant windows is displayed on the computing device and in this example, the local participant is a user of the computing device where the plurality of participant windows is displayed.

Capture instructions 728, when executed by the processor 216, cause the processor 216 to, capture an image of a face of the local participant 210 based on the detection as described above in connection with FIG. 1.

Adjust instructions 626, when executed by the processor 216, cause the processor 216 to adjust a position of the iris of the local participant from a side position to a center position as described above in connection with FIG. 1.

Transmit instructions 730, when executed by the processor 216, cause the processor 216 to transmit the iris position adjustment to a plurality of remote participant computing devices as described above in connection with FIG. 1. Doing so changes an appearance of the local participant 210 in a participant window of the first remote participant computing device of the plurality of remote participant computing devices.

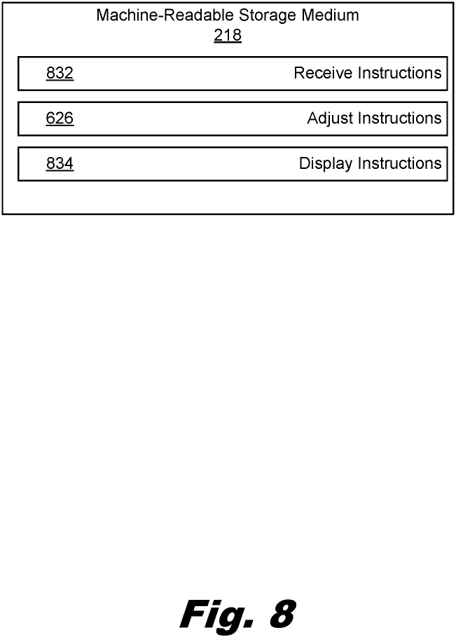

FIG. 8 depicts a non-transitory machine-readable storage medium 218 for receiving raw data for iris position adjustments from a remote participant computing device, according to an example. In the example depicted in FIG. 8, rather than making an adjustment and then transmitting the adjustment to other participant computing devices, the raw data associated with the adjustment is sent to the participant computing devices, at which point each participant computing device performs the adjustment. Put another way, in FIG. 7, adjustments to a local participant’s iris position are sent to remote participant computing devices. In the example depicted in FIG. 8, raw data relating to a remote participant’s iris position is received at the local participant computing device 212 and the adjustments are made at the local participant computing device 212.

Accordingly, receive instructions 832, when executed by the processor 216, cause the processor 216 to, receive an indication that a first remote participant in a videoconference is looking at a local participant window of a plurality of participant windows as described above in connection with FIG. 3. In this example the plurality of participant windows is displayed on a first remote computing device and the local participant 210 is a user of the computing device where the adjustments are made. Adjust instructions 626, when executed by the processor 216, cause the processor 216 to adjust a position of the iris of the first remote participant from a side position to a center position as described above in connection with FIG. 3. Display instructions 834, when executed by the processor 216, cause the processor 216 to display a first remote participant window based on the iris position adjustment for the first remote participant as described above in connection with FIG. 3.

What is claimed is:

1. A non-transitory machine-readable storage medium encoded with instructions executable by a processor of a computing device to, when executed by the processor, cause the processor to:
detect that a local participant in a videoconference is looking at a first remote participant window of a plurality of participant windows, wherein:
the plurality of participant windows is displayed via the computing device; and
the local participant is a user of the computing device;
capture an image of a face of the local participant based on the detection;
adjust a position of an iris of the local participant from a side position to a center position; and
transmit an iris position adjustment to a plurality of remote participant computing devices to change an appearance of the local participant in a participant window displayed in a first remote participant computing device of the plurality of remote participant computing devices.

2. The non-transitory machine-readable storage medium of claim 1, further comprising instructions executable by the processor to cause the processor to:
determine a gaze point of the local participant;
extract a layout of windows on the computing device; and
detect that the local participant is looking at the first remote participant window based on the gaze point and layout of windows.

3. The non-transitory machine-readable storage medium of claim 2, further comprising instructions executable by the processor to cause the processor to compare a captured image against a training set of images of user eye positions.

4. The non-transitory machine-readable storage medium of claim 3, further comprising instructions executable by the processor to cause the processor to adjust the position of the iris of the local participant based on the training set.

5. The non-transitory machine-readable storage medium of claim 1, wherein the instructions to adjust a position of an iris of the local participant comprise instructions to adjust pixels associated with the iris.

6. The non-transitory machine-readable storage medium of claim 1, further comprising instructions executable by the processor to cause the processor to:
adjust a position of a head of the local participant based on the iris position adjustment; and
transmit a head position adjustment to the plurality of remote participant computing devices.

7. The non-transitory machine-readable storage medium of claim 1, further comprising instructions to cause the processor to:
receive from the first remote participant computing device, an iris position adjustment for a first remote participant, which iris position adjustment is to adjust a position of an iris of the first remote participant from a side position to a center position; and
display the first remote participant window based on the iris position adjustment for the first remote participant.

8. The non-transitory machine-readable storage medium of claim 7, further comprising instructions executable by the processor to cause the processor to:
receive from the first remote participant computing device, a head position adjustment for the first remote participant based on the iris position adjustment; and
display the first remote participant window based on the head position adjustment for the first remote participant.

9. The non-transitory machine-readable storage medium of claim 1, further comprising instructions executable by the processor to cause the processor to prompt the user through a sequence of calibration eye movements.

10. A non-transitory machine-readable storage medium encoded with instructions executable by a processor of a computing device to, when executed by the processor, cause the processor to:
receive an indication that a first remote participant in a videoconference is looking at a local participant window of a plurality of participant windows, wherein:
the plurality of participant windows is displayed via a first remote participant computing device; and
a local participant is a user of the computing device;
adjust a position of an iris of the first remote participant from a side position to a center position; and
display a first remote participant window based on an iris position adjustment for the first remote participant.

11. The non-transitory machine-readable storage medium of claim 10, wherein a received indication indicates:
a gaze region for the first remote participant; and
a position of a capture device on the first remote participant computing device.

12. The non-transitory machine-readable storage medium of claim 11, wherein a received indication indicates a window layout on the first remote participant computing device.

13. The non-transitory machine-readable storage medium of claim 10, wherein a received indication indicates a discrepancy angle between a gaze region for the first remote participant and a position of a capture device on the first remote participant computing device.

14. The non-transitory machine-readable storage medium of claim 10, further comprising instructions executable by the processor to cause the processor to adjust a head position of the first remote participant based on an iris position adjustment.

15. The non-transitory machine-readable storage medium of claim 10, further comprising instructions executable by the processor to cause the processor to:
receive an indication that the first remote participant is looking at a second remote participant window of the plurality of participant windows;
receive an indication of a layout of windows on the computing device; and
adjust based on the layout of windows, a position of an iris of the first remote participant towards a second remote participant window.

16. The non-transitory machine-readable storage medium of claim 15, further comprising instructions executable by the processor to cause the processor to adjust a position of a head of the first remote participant based on an iris position adjustment of the first remote participant.

17. The non-transitory machine-readable storage medium of claim 15, further comprising instructions executable by the processor to cause the processor to adjust a position of an iris of a second remote participant towards a first remote participant window.

18. The non-transitory machine-readable storage medium of claim 17, further comprising instructions executable by the processor to cause the processor to adjust a position of a head of the second remote participant based on an iris position adjustment of the second remote participant.

19. A non-transitory machine-readable storage medium encoded with instructions executable by a processor of a computing device to, when executed by the processor, cause the processor to:
detect that a local participant in a videoconference is looking at a first remote participant window of a plurality of participant windows, wherein the plurality of participant windows is displayed via a local participant computing device;
based on a window layout of a first remote participant computing device adjust a position of an iris of the local participant from a side position to a position focused on a first remote participant; and
based on a window layout of a second remote participant computing device adjust a position of the iris of the local participant from the side position to the position focused on the first remote participant.

20. The non-transitory machine-readable storage medium of claim 19, further comprising instructions executable by the processor of to, cause the processor to identify, from a captured image, a gaze region for the local participant, the gaze region indicating a location on the computing device where the local participant is looking.
